(19) United States
(12) Patent Application Publication
(10) Pub. No.: US 2010/0255408 A1
(43) Pub. Date: Oct. 7, 2010

(54) FUEL CELL STRUCTURE

(76) Inventors: Ming-San LEE, Kaohsiung City (TW); Long-Jeng Chen, Kaohsiung City (TW); Wei-Ting Shiu, Kaohsiung City (TW); Bo-Yu Liu, Kaohsiung City (TW); Yu-Wei Huang, Kaohsiung City (TW); Wei-Cheng Chan, Kaohsiung City (TW); You-Min Su, Kaohsiung City (TW)

Correspondence Address: Muncy, Geissler, Olds & Lowe, PLLC, 4000 Legato Road, Suite 310, FAIRFAX, VA, 22033, US

(21) Appl. No.: 12/626,192

(22) Filed: Nov. 25, 2009

(30) Foreign Application Priority Data
Apr. 3, 2009 (TW) 098111317
Apr. 24, 2009 (TW) 098113816

(51) Int. Cl. H01M 2/02

(52) U.S. Cl. 429/519

(57) ABSTRACT

A fuel cell structure mainly comprises a frame and a membrane electrode assembly. The frame has an inside wall, and the membrane electrode assembly comprises a first electrode, a second electrode, and an electrolyte membrane disposed between the first electrode and the second electrode. The electrolyte membrane having an electrode joint portion and an adhesive portion. The first electrode and the second electrode are laid on two opposite sides of the electrode joint portion separately. The adhesive portion is attached onto the inside wall.

### FIELD OF THE INVENTION

The present invention is generally relating to a fuel cell structure, more particularly to a fuel cell structure with flexibility.

### BACKGROUND OF THE INVENTION

With reference to FIG. 1, a known fuel cell structure 100 comprises at least a membrane electrode assembly (MEA) 110, a first ending plate 120, a second ending plate 130, a first seal gasket 140, a second seal gasket 150 and a plurality of fixing elements 160. The membrane electrode assembly 110 has an electrolyte membrane 111, a first electrode 112 attached to one side of the electrolyte membrane 111 and a second electrode 113 attached to another side of the electrolyte membrane 111. The first ending plate 120 and the second ending plate 130 are laid on two opposite sides of the membrane electrode assembly 110 separately. In order to prevent gas leakage the first seal gasket 140 and the second seal gasket 150 are positioned between the first ending plate 120 and the first electrode 112, the second ending plate 130 and the second electrode 113 separately. The fixing element 160 is utilized to integrate the first ending plate 120, the second ending plate 130, the first seal gasket 140 and the second seal gasket 150 at the membrane electrode assembly 110 so as to compose the fuel cell structure 100. However, the fuel cell structure 100 is composed of many elements and the first and second ending plates 120, 130 are rigid plate, so that commodity of the fuel cell structure 100 is not marketable due to some defects such as component-complicated, fragile, bulky, heavy and costly, etc.

### SUMMARY

A primary object of the present invention is to provide a fuel cell structure comprising a frame and a membrane electrode assembly. The frame has an inside wall, the membrane electrode assembly comprises a first electrode, a second electrode, and an electrolyte membrane disposed between the first electrode and the second electrode. The electrolyte membrane having an electrode joint portion and an adhesive portion disposed at periphery of the electrode joint portion. The first electrode and the second electrode are laid on two opposite sides of the electrode joint portion separately, the adhesive portion is attached onto the inside wall. The fuel cell structure is composed by disposing the membrane electrode assembly on the inside wall of the frame without the use of butt joint element and fixing element, which enables the fuel cell structure obtaining some merits such as simple structure, light weight and low cost, etc.

A secondary object of the present invention is to provide a fuel cell structure comprising a frame, a first membrane electrode assembly and a second membrane electrode assembly. The frame has an inside wall. The first membrane electrode assembly comprises a first electrode, a second electrode, and a first electrolyte membrane disposed between the first electrode and the second electrode, in which the first electrolyte membrane having a first electrode joint portion and a first adhesive portion disposed at periphery of the first electrode joint portion, the first electrode and the second electrode are laid on two opposite sides of the first electrode joint portion separately, the first adhesive portion is attached onto the inside wall of the frame. The second membrane electrode assembly comprises a third electrode, a fourth electrode, and a second electrolyte membrane disposed between the third electrode and the fourth electrode, in which the second electrolyte membrane having a second electrode joint portion and a second adhesive portion disposed at periphery of the second electrode joint portion, the third electrode and the fourth electrode are laid on two opposite sides of the second electrode joint portion, the second adhesive portion is attached onto the side wall of the frame separately. The fuel cell structure comprising the first membrane electrode assembly and the second membrane electrode assembly can form a stacked type fuel cell structure by stacking the first membrane electrode assembly and the second membrane electrode assembly to not only increase use efficiency and use lifetime thereof but also save cost of butt joint plate and fixing element, hence the fuel cell structure has some merits such as simple structure, light weight, high use efficiency, long use lifetime and low cost, etc.

### DESCRIPTION OF THE DRAWINGS

FIG. 1 is a cross-sectional view illustrating a known fuel cell structure.

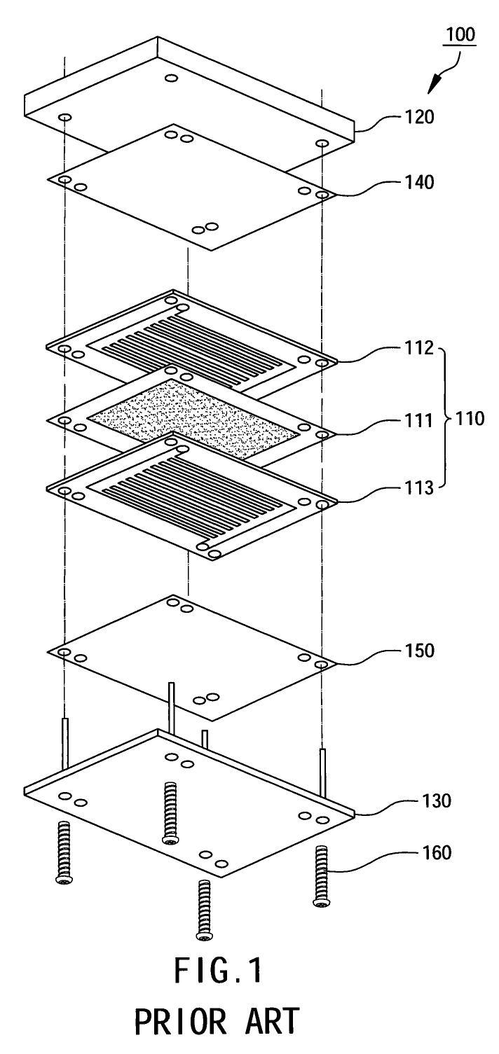

FIG. 2 is a perspective view illustrating a fuel cell structure in accordance with the first embodiment of the present invention.

FIG. 3 is a perspective exploded view illustrating the fuel cell structure along A-A line of FIG. 2 in accordance with the first embodiment of the present invention.

FIG. 4 is a cross-sectional view illustrating the fuel cell structure in accordance with the first embodiment of the present invention.

FIG. 5 is a cross-sectional view illustrating another fuel cell structure in accordance with the second embodiment of the present invention.

FIG. 6 is a cross-sectional view illustrating yet another fuel cell structure in accordance with the third embodiment of the present invention.

### DETAILED DESCRIPTION OF THE INVENTION

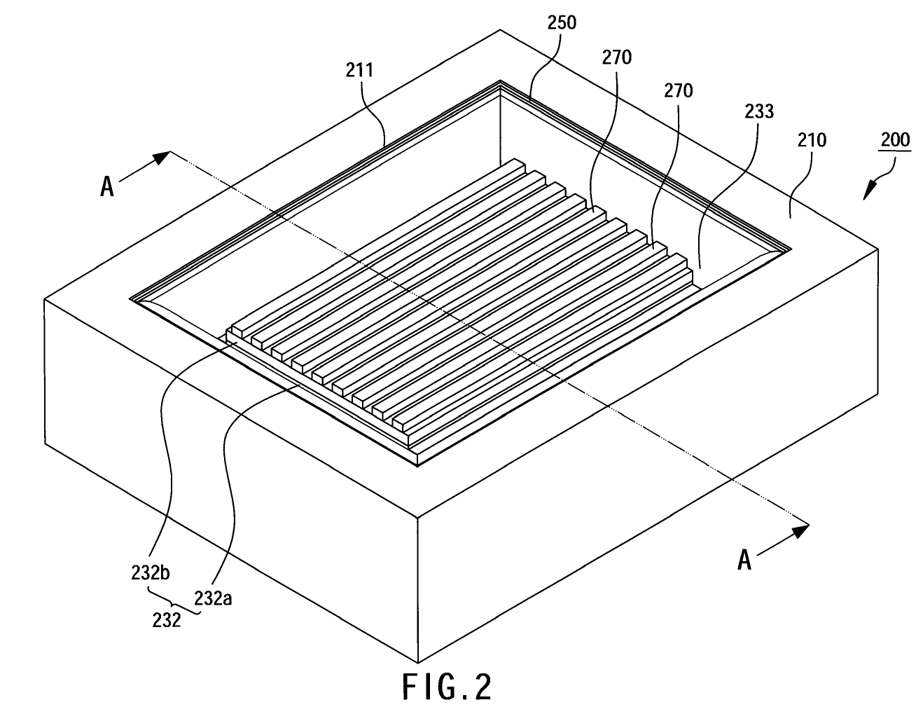

With reference to FIGS. 2, 3 and 4, a fuel cell structure 200 in accordance with the first embodiment of the present invention comprises a frame 210, a first membrane electrode assembly (MEA) 220, a second membrane electrode assembly 230, a first glue 240 and a second glue 250. The frame 210 has an inside wall 211. The first membrane electrode assembly 220 comprises a first electrode 221, a second electrode 222, and a first electrolyte membrane 223 disposed between the first electrode 221 and the second electrode 222, in which the first electrode 221 comprises a first catalyst layer 221a and a first diffusion layer 221b, the second electrode 222 comprises a second catalyst layer 222a and a second diffusion layer 222b, the first electrolyte membrane 223 having a first electrode joint portion 223a and a first adhesive portion 223b disposed at periphery of the first electrode joint portion 223a. Within this embodiment, the first adhesive portion 223b of the first electrolyte membrane 223 further comprising a first bending section 223c adjacent to the first electrode joint portion 223a, and a first adhesive section 223d adjacent to the first bending section 223c. The first electrode 221 is attached to one side of the first electrode joint portion 223a, the second electrode 222 is oppositely attached to another side of the first electrode joint portion 223a, the first adhesive section 223d of the first adhesive portion 223b is attached onto the inside wall 211 of the frame 210. Likewise, the second membrane electrode assembly 230 comprises a third electrode 231, a fourth electrode 232, and a second electrolyte membrane 233 disposed between the third electrode 231 and the fourth electrode 232, in which the third electrode 231 comprises a third catalyst layer 231a and a third diffusion layer 231b, the fourth electrode 232 comprises a fourth catalyst layer 232a and a fourth diffusion layer 232b, the second electrolyte membrane 233 having a second electrode joint portion 233a and a second adhesive portion 233b disposed at periphery of the second electrode joint portion 233a. The second adhesive portion 233b of the second electrolyte membrane 233 further comprising a second bending section 233c adjacent to the second electrode joint portion 233a, and a second adhesive section 233d adjacent to the second bending section 233c. The third electrode 231 is attached to one side of the second electrode joint portion 233a, the fourth electrode 232 is oppositely attached to another side of the second electrode joint portion 233a, the second adhesive section 233d of the second adhesive portion 233b is attached onto the inside wall 211 of the frame 210 separately. The first electrode 221 and the third electrode 231 are oppositely disposed between the first electrolyte membrane 223 and the second electrolyte membrane 233, in which the first electrode 221 is attached to the first electrode joint portion 223a of the first electrolyte membrane 223, the third electrode 231 is attached to the second electrode joint portion 233a of the second electrolyte membrane 233. Within this embodiment, the first electrolyte membrane 223, the second electrolyte membrane 233, and the inside wall 211 of the frame 210 forming a closed space. The first glue 240 is disposed between the first adhesive section 223d of the first adhesive portion 223b and the inside wall 211, the second glue 250 is disposed between the second adhesive section 233d of the second adhesive portion 233b and the inside wall 211. The material of the first glue 240 may be same as that of the second glue 250 and the material of both can also be replaced by film.

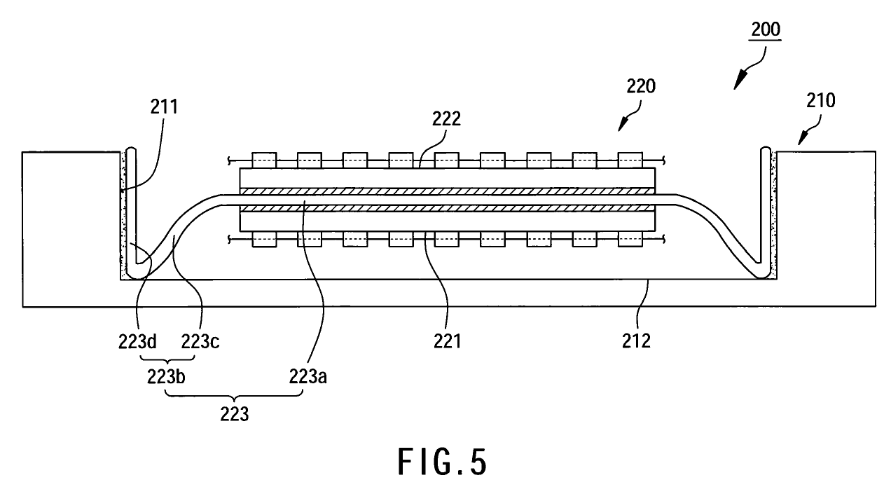

Besides, with reference to FIG. 5, the fuel cell structure 200 in accordance with another embodiment may merely comprise a frame 210 and a membrane electrode assembly 220. The frame 210 has an inside wall 211 and further comprises a bottom surface 212, in which the frame 210 or the bottom surface 212 is made of flexible material. The membrane electrode assembly 220 comprises a first electrode 210, a second electrode 222 and an electrolyte membrane 223 disposed between the first electrode 221 and the second electrode 222. The electrolyte membrane 223 having an electrode joint portion 223a and an adhesive portion 223b disposed at periphery of the electrode joint portion 223a. The first electrode 221 and the second electrode 222 are laid on two opposite sides of the electrode joint portion 223a separately, the adhesive portion 223b is attached onto the inside wall 211. The adhesive portion 223b of the electrolyte membrane 223 further comprising a bending section 223c adjacent to the electrode joint portion 223a and an adhesive section 223d connecting with the bending section 223c. The adhesive section 223d is attached onto the inside wall 211 of the frame 210. The first electrode 221 disposed between the bottom surface 212 and the electrode joint portion 223a is attached to one side of the electrode joint portion 223a, and the second electrode 222 is oppositely attached to another side of the electrode joint portion 223a. The bending section 223c of the adhesive portion 223b positioned between the adhesive section 223d and the electrode joint portion 223a contacts against the bottom surface 212.

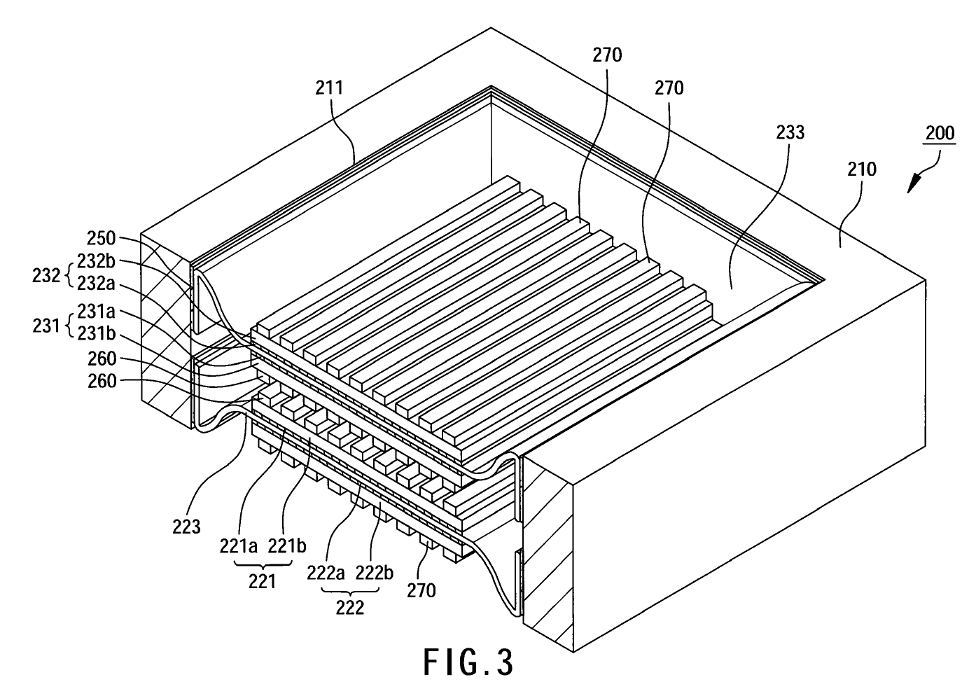

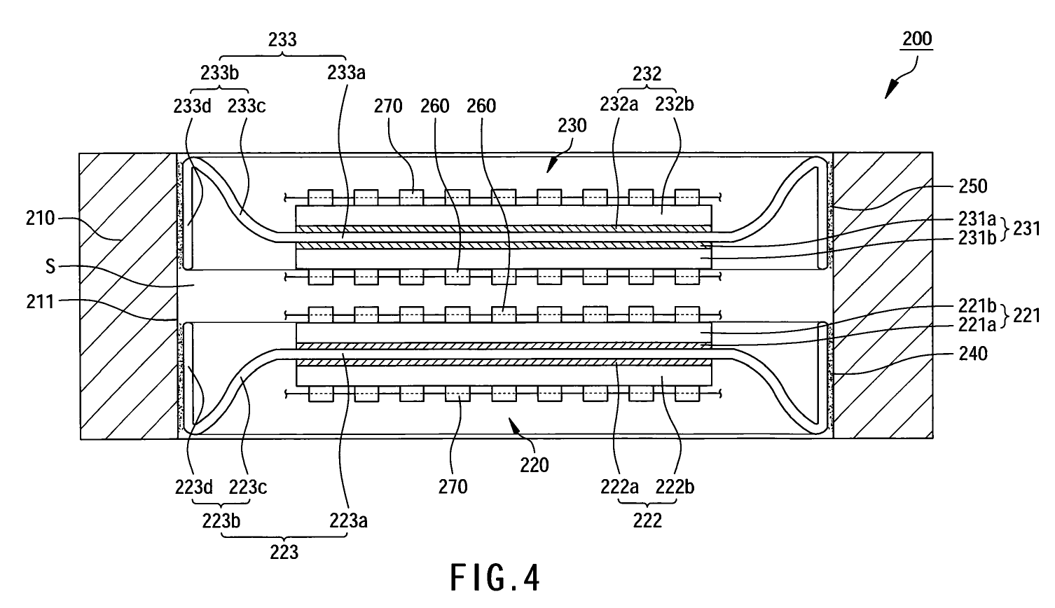

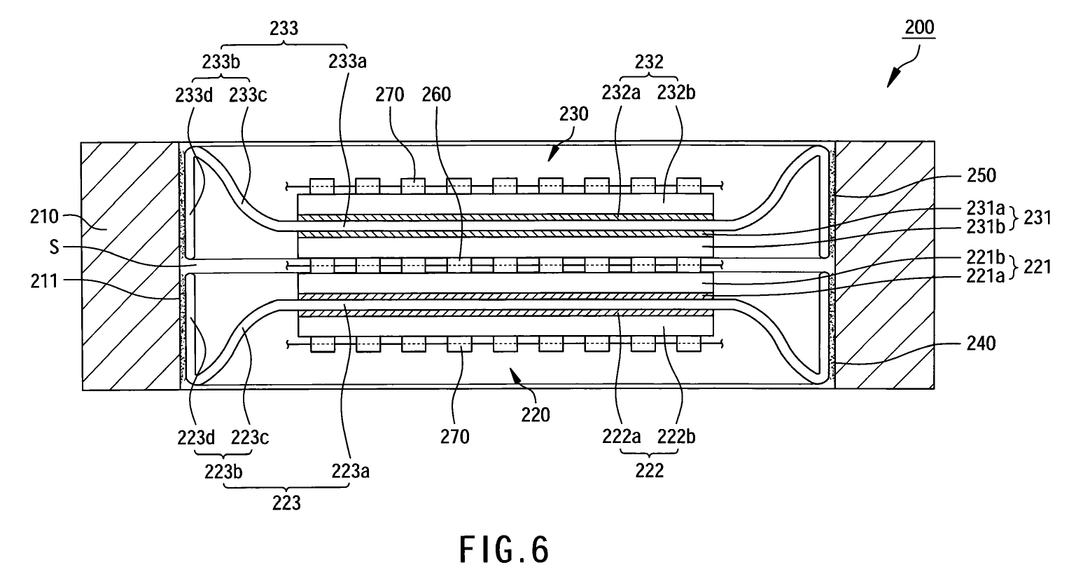

Moreover, with reference to FIGS. 3 and 4, the fuel cell structure 200 further comprises a plurality of first current collecting elements 260 and two second current collecting elements 270, in which the first current collecting elements 260 are connected with the first electrode 221 of the first membrane electrode assembly 220 and the third electrode 231 of the second membrane electrode assembly 230 separately, the two second current collecting elements 270 are connected with the second electrode 222 of the first membrane electrode assembly 220 and the fourth electrode 232 of the second membrane electrode assembly 230 separately. Or with reference to FIG. 6, within another embodiment, the fuel cell structure 200 yet further comprises a first current collecting element 260 connecting with the first electrode 221 of the first membrane electrode assembly 220 and the third electrode 231 of the second membrane electrode assembly 230. The fuel cell structure 200 comprising the first membrane electrode assembly 220 and the second membrane electrode assembly 230 can form a stacked type fuel cell structure by stacking the first membrane electrode assembly 220 and the second membrane electrode assembly 230, thereby enhancing use efficiency and lifetime of the fuel cell structure 200. In addition, the fuel cell structure 200 utilizes the first electrolyte membrane 223, the second electrolyte membrane 233 and the inside wall 211 of the frame 210 to form the closed space S, which may omit butt joint element and fixing element and allow the fuel cell structure 200 obtaining some merits such as simple structure, light weight, high use efficiency, long use lifetime and low cost, etc.

While this invention has been particularly illustrated and described in detail with respect to the preferred embodiments thereof, it will be clearly understood by those skilled in the art that is not limited to the specific features shown and described and various modified and changed in form and details may be made without departing from the spirit and scope of this invention.

What is claimed is:

1. A fuel cell structure comprising:
a frame having an inside wall; and
a membrane electrode assembly comprising a first electrode, a second electrode, and an electrolyte membrane disposed between the first electrode and the second electrode, wherein the electrolyte membrane having an electrode joint portion and an adhesive portion disposed at periphery of the electrode joint portion, the first electrode and the second electrode are laid on two opposite sides of the electrode joint portion separately, the adhesive portion is attached onto the inside wall.

2. The fuel cell structure in accordance with claim 1, wherein the frame further comprising a bottom surface, the first electrode is disposed between the bottom surface and the electrode joint portion and attached to one side of the electrode joint portion, the second electrode is oppositely attached to another side of the electrode joint portion.

3. The fuel cell structure in accordance with claim 1, wherein the adhesive portion of the electrolyte membrane further comprising:
a bending section adjacent to the electrode joint portion;
an adhesive section connecting with the bending section; and
the adhesive section is attached onto the inside wall of the frame.

4. The fuel cell structure in accordance with claim 3, wherein the bending section of the adhesive portion is positioned between the adhesive section and the electrode joint portion.

5. The fuel cell structure in accordance with claim 3, further comprising a glue disposed between the adhesive section of the adhesive portion and the inside wall.

6. The fuel cell structure in accordance with claim 1, further comprising at least a first current collecting element adjacent to the first electrode of the membrane electrode assembly.

7. The fuel cell structure in accordance with claim 6, further comprising at least a second current collecting element adjacent to the second electrode of the membrane electrode assembly.

8. The fuel cell structure in accordance with claim 1, wherein the frame or the bottom surface is made of flexible material.

9. A fuel cell structure comprising:
a frame having an inside wall;
a first membrane electrode assembly comprising a first electrode, a second electrode, and a first electrolyte membrane disposed between the first electrode and the second electrode, wherein the first electrolyte membrane having a first electrode joint portion and a first adhesive portion disposed at periphery of the first electrode joint portion, the first electrode and the second electrode are laid on two opposite sides of the first electrode joint portion separately, the first adhesive portion is attached onto the inside wall of the frame; and
a second membrane electrode assembly comprising a third electrode, a fourth electrode, and a second electrolyte membrane disposed between the third electrode and the fourth electrode, wherein the second electrolyte membrane having a second electrode joint portion and a second adhesive portion disposed at periphery of the second electrode joint portion, the third electrode and the fourth electrode are laid on two opposite sides of the second electrode joint portion, the second adhesive portion is attached onto the inside wall of the frame separately.

10. The fuel cell structure in accordance with claim 9, wherein the first electrode and the third electrode are oppositely disposed between the first electrolyte membrane and the second electrolyte membrane, the first electrode is attached to the first electrode joint portion of the first electrolyte membrane, the third electrode is attached to the second electrode joint portion of the second electrolyte membrane.

11. The fuel cell structure in accordance with claim 10, wherein the first electrolyte membrane, the second electrolyte membrane, and the inside wall of the frame forming a closed space.

12. The fuel cell structure in accordance with claim 9, further comprising a first current collecting element connecting with the first electrode of the first membrane electrode assembly.

13. The fuel cell structure in accordance with claim 12, wherein the first current collecting element connecting with the third electrode of the second membrane electrode assembly.

14. The fuel cell structure in accordance with claim 13, further comprising two second current collecting elements separately connecting to the second electrode of the first membrane electrode assembly and the fourth electrode of the second membrane electrode assembly.

15. The fuel cell structure in accordance with claim 9, further comprising a plurality of first current collecting elements separately connecting to the first electrode of the first membrane electrode assembly and the third electrode of the second membrane electrode assembly.

16. The fuel cell structure in accordance with claim 15, further comprising two second current collecting elements separately connecting with the second electrode of the first membrane electrode assembly and the fourth electrode of the second membrane electrode assembly.

17. The fuel cell structure in accordance with claim 9, wherein the first adhesive portion of the first electrolyte membrane further comprising:
a first bending section adjacent to the first electrode joint portion; and
a first adhesive section adjacent to the first bending section, wherein the first adhesive section is attached onto the inside wall of the frame.

18. The fuel cell structure in accordance with claim 17, wherein the second adhesive portion of the second electrolyte membrane further comprising:
a second bending section adjacent to the second electrode joint portion; and
a second adhesive section adjacent to the second bending section, wherein the second adhesive section is attached onto the inside wall of the frame.

19. The fuel cell structure in accordance with claim 18, further comprising:
a first glue disposed between the first adhesive section of the first adhesive portion and the inside wall; and
a second glue disposed between the second adhesive section of the second adhesive portion and the inside wall.
